(19) United States
(12) Patent Application Publication
(10) Pub. No.: US 2004/0255787 A1
(43) Pub. Date: Dec. 23, 2004

(54) Dispenser with submersible passive heating unit, submersible passive heating unit and method

(76) Inventors: Michael W. Lassota, Wauconda, IL (US); Zbigniew G. Lassota, Long Grove, IL (US)

Correspondence Address: James W. Potthast, Potthast & Associates, 2712 N. Ashland Avenue, Chicago, IL, 60614-1106, US

(21) Appl. No.: 10/835,799

(22) Filed: Apr. 30, 2004

Related U.S. Application Data
(63) Continuation-in-part of application No. 10/350,195, filed on Jan. 23, 2003.
Application No. 10/350,195 is a division of application No. 09/841,399, filed on Apr. 24, 2001, now Pat. No. 6,606,937.
(60) Provisional application No. 60/199,628, filed on Apr. 25, 2000.

(51) Int. Cl. A23L 1/00

(52) U.S. Cl. 99/275

(57) ABSTRACT

A self-heating beverage dispenser assembly (10) with an insulated hollow body (18) with an interior space (16) for receipt of hot beverage (14) at an initial beverage temperature is provided with a beverage submersible passive heating element (12) submersed in the beverage and having a body with an interior core (48) made of heat retentive material, such a phase change material or ceramic material or the like, and surrounded by a protective outer shell (46) made of material substantially impervious to contact with hot beverage (14). The core (48) is preheated to an initial internal temperature significantly greater than the initial beverage temperature to transfer heat from the core (48) to the beverage (13) within the container, said self-contained passive heating element being contained within the interior of the hollow body. A passive heating unit energizer (44) selectively heats the passive heating unit (12) to the desired initial internal temperature.

### CROSS-REFERENCE TO RELATED APPLICATION

This application is a continuation-in-part of, and claims the benefit, under 35 USC 120 of U.S. application Ser. No. 10/350,195 filed Jan. 23, 2003, of Zbigniew G. Lassota and entitled “Method for Maintaining Temperature of a Beverage in a Hot Beverage Serving Urn” which, in turn, is a divisional of, and claims the benefit under 35 USC 120, of U.S. application Ser. No. 09/841,399 filed Apr. 24, 2001, of Zbigniew G. Lassota and entitled “Self-heating Hot Beverage Serving Urn and Method”, now U.S. Pat. No. 6,606,937 which, in turn, claims the benefit under 35 USC 119(e) of provisional application Ser. No. 60/199,628 filed Apr. 25, 2000 of Zbigniew G. Lassota, the contents of all of which are hereby incorporated by reference.

### BACKGROUND OF THE INVENTION

1. Field of the Invention

This invention relates to a dispensing beverage dispenser for storing and serving hot beverage, and more particularly, to such a dispenser that is insulated but has no electrical heater to maintain the temperature of the beverage and a method of maintaining the temperature of hot beverage in such a dispenser.

2. Discussion of the Prior Art

Coffee urns of the type into which coffee is directly brewed at a brewing location and then moved to a serving location where the coffee, tea or other brewed beverage is served from a serving faucet, or spigot, are well known in the art of brewing and serving of hot coffee and tea. In order to keep the brewed beverage at the desired temperature at which it was freshly brewed, it is generally preferable to fill the urn with the hot beverage. Such urns come in different sizes such as one, one and one half, two and three gallons.

A problem with such serving urns is that often the coffee becomes too cool for good quality before the urn is depleted. In order to overcome this problem, it is known to an internal or external electrically powered heating element. It is also known to insulate the urn to reduce heat loss after the urn is filled with beverage. Heat loss occurs by way of radiation. Heat loss also occurs by direct loss when hot beverage is served from the dispensing urn, and the heat of the beverage is physically removed from the beverage. As a consequence of such heat loss, the serving time during which the beverage is still above the minimum serving temperature, for best flavor and desirability, is only approximately one to one and one half hours if the dispensing urn is initially filled to capacity. If the urn is not filled to capacity but is only half filled, for instance, then the serving time may be reduced proportionately with the reduction in percentage of full capacity. Part of the problem is that the NSF and brewer industry standards require the use of stainless steel that has a relatively high rate of heat transfer.

The known ways of overcoming this serving time limitation include not moving the serving urn from the location at which it is brewed and keeping it on an external hot plate or other external heating element at the brewing location. This approach disadvantageously ties up the brewing location such that other urns cannot be filled, and, of course, demands that servers return to the original brewing location to serve the beverage into a smaller serving container such as a carafe or into a cup for direct service.

Alternatively, it is know to move the urn closer to the serving location and then place it on an electrical hot plate at another location or, to provide the urn with an internal heating element that is plugged into an AC power outlet for receipt of electrical power at a remote location in order to maintain the temperature of the beverage at the desired temperature. The need for a source of electrical power, at hand, to power the hot plate or internal heating element, and is not convenient when it is desired to locate the urn in a central location away from an AC power wall outlet. Even if there are floor outlets, if the urn is placed on a table, then a-power cord must come up from the floor and rest upon table to reach the hot plate or the connection to the urn, itself, in the case of an internal, electrically powered heating element.

Another problem with electrical heaters is that controlling the heating element requires a thermo-mechanical or electronic thermostat to insure that not to much heat is added to the urn. Too much heat due to power surges or improper calibration can result in reduction of the beverage due to evaporation and overheating of the flavor elements of the brew. Both of these conditions may undesirably alter the flavor and aroma of the beverage being served. Coffee that is served too hot can also create risk of scalding and potential civil liability to the server. Likewise, there may be an increased risk of liability associated with electrical power cords lying on a service floor and hot plates and continuously electrically powered or thermostatically controlled electrically powered heating elements.

As a consequence of the problems associated with electrically powered heating elements and hot plates, noted above, and also with the non-heated, insulated urn which does not keep the beverage above a minimum desired temperature for longer than 1-2 hours, particularly in the case of less than a full brew capacity filling the urn, there is an unfulfilled need in the market of commercial coffee brewers and serving systems and the like for methods for maintaining temperature of hot beverages within a a serving urn that overcomes these limitations and disadvantages.

In the aforementioned patent applications set forth above apparatus and methods are disclosed in which an insulated, hot beverage dispenser is provided with a warming element fixedly or removably mounted to the exterior of the hollow dispenser body but in thermal communication with the beverage within the interior of the dispenser body. The warming element is heated during the time that the dispenser is engaged with a hot beverage brewer to receive freshly brewed beverage directly into the dispenser to a temperature that is greater than that of the hot beverage. After the dispenser is removed from the brewer and from sources of electrical power to a serving station, the heating element gradually releases heat energy through the wall of the dispenser body to assist in maintaining the temperature. While this invention is very useful, because it requires special features to be built into the dispenser when the dispenser is first constructed, it is not well adapted to be added to an existing dispenser after the dispenser is first built without these special features.

### SUMMARY OF THE INVENTION

Accordingly, in accordance with the present invention the advantages of the self-heating dispenser of the invention of the parent application of the present application are obtained in such a fashion that existing dispensers that have no self heating feature may be retrofitted with the submersible beverage warmer of the present invention to make them into self-warming dispensers even though they are not fitted with the special features otherwise needed for self-heating.

This objective is achieved in part by provision of a self-heating beverage dispenser with a a beverage dispenser assembly with a hollow body with an interior for receipt of hot beverage at an initial beverage temperature and a a beverage submersible passive heating element having body with an interior and an outer surface made of material substantially impervious to contact with hot beverage and having an initial internal temperature significantly greater than the initial beverage temperature to transfer heat from the interior of the body to any beverage within the container, said self-contained passive heating element being contained within the interior of the hollow body.

The objective is also acquired by providing a submersible passive heating unit for passively heating a beverage in which the passive heating unit is submersed having a core made of heat retentive material and an exterior surface made of material that is impervious to hot beverages and approved for contact with food during commercial preparation.

Also, achievement of the objective of the invention is obtained by providing a method of maintaining freshly brewed beverage by performance of the steps of depositing freshly brewed beverage into a beverage container, submerging in the freshly brewed beverage at least one energized passive heating unit having heat retentive material and a temperature greater than that of the beverage, passing heat from the passive heating unit to the beverage to assist in maintaining the temperature of the beverage above a preselected minimum service temperature.

### BRIEF DESCRIPTION OF THE DRAWINGS

The foregoing advantageous features and advantages will be described in greater detail and further features and advantages will be made apparent in the detailed description given below with reference to the several figures of the drawing, in which:

FIG. 1 is a schematic sectional side view illustration of an insulated beverage dispenser of the present invention showing use of the passive heating units located at the bottom of the unit;

FIG. 2 is an enlarged schematic illustration of one form of the passive heating unit of FIG. 1;

FIG. 3 is a schematic sectional side view illustration of an insulated beverage dispenser of the present invention showing use of another of form of the passive heating unit that is removably mounted a down-tube of a funnel assembly of the dispenser;

FIG. 4 is an enlarged schematic illustration of the other form of the passive heating unit of FIG. 3;

FIG. 5 is a side view of yet another form of the passive heating unit that has an ovoid shape;

FIG. 6 is a side view of still another form of the passive heating unit that has a cylindrical or torroidal;

FIG. 7 is a side view of still another form of the passive heating unit that has a removable handle for lowering and removing the passive heating unit into and out of the interior of the insulated beverage dispenser;

FIG. 8 is a functional block diagram of a beverage brewing system constructed in accordance with the present invention; and

FIG. 9 is a flow chart illustrating the method of dispensing freshly brewed beverage in accordance with the present invention.

### DETAILED DESCRIPTION

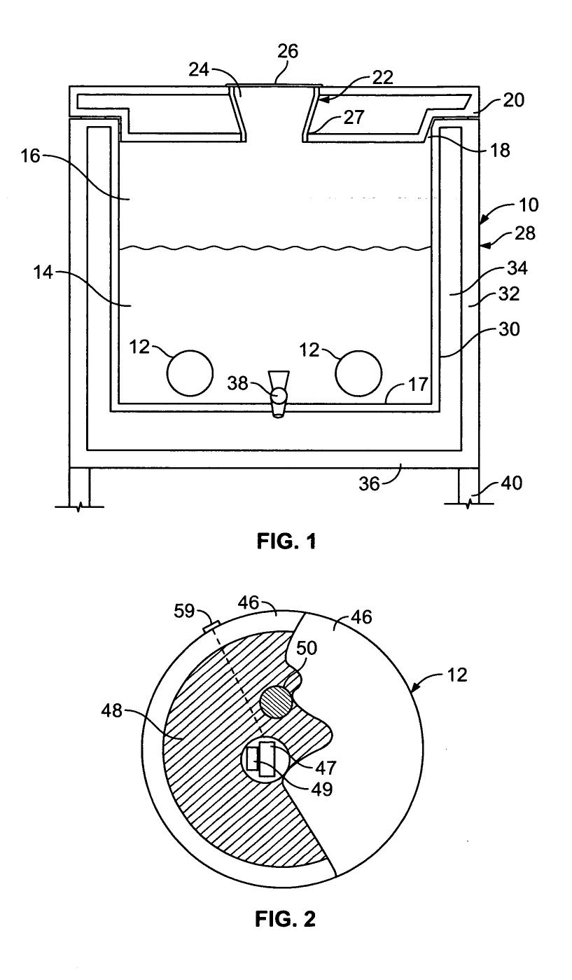

Referring now to FIG. 1, the insulated beverage dispenser 10 of the present invention has been retrofit with passive heating units 12 that have been submerged in the beverage 14 within the interior 16 of the beverage dispenser 10. The insulated beverage dispenser 10 has an open top 18 that is closed by an insulated double-walled, movably mounted cover 20. Carried at the top of the cover 20 is a funnel assembly 22 with a funnel passageway 24 for direct receipt from a matching brewer of freshly brewed beverage 14 and a funnel cover 26 that is movably mounted to close the funnel opening after the beverage has been added to the interior 16. The beverage dispenser also has a double-walled insulated cylindrical body 28 with an interior wall 30 and an exterior wall 32 separated by a gap 34. The gap 34 is preferably evacuated or filled with insulation material. A bottom 36 is supported above a support surface, such as a countertop or top of a serving cart, by means of a base 40 so that serving containers may be located underneath a faucet 38 that is used to serve the beverage from adjacent the bottom 36.

The associated brewer 42, shown in functional block form in FIG. 8 has all of the customary brewer elements including a hot water reservoir, dispense valves for dispensing the hot water into the top of a removable brew basket 14, a controller for controlling the dispense valve and other elements of the brewer 12. These conventional elements of the brewer form no part of the present invention, and reference may be made to U.S. Pat. No. 5,000,082 issued to Lassota on Mar. 19, 1991 for “Beverage Maker and Method of Making Beverage”; U.S. Pat. No. 5,331,885 issued to Lassota on Jul. 26, 1994 for “Semiautomatic Beverage Maker and Method”; U.S. Pat. No. 5,943,944 issued to Lassota on Aug. 31, 1999, for “Brewing System with Hot Water Urn Flushing Apparatus”; U.S. Pat. No. 5,953,981 issued to Lassota on Sep. 21, 1999; and patents cited therein, hereby incorporated by reference, for further information concerning such standard features.

Likewise, the details of the beverage dispenser 10, other than the details of the passive heating units 12 form no part of the invention. If further information concerning the details of a beverage dispenser that may benefit from the present invention, reference should be made to one or more of U.S. Pat. No. 6,705,208 issued Mar. 16, 2004; U.S. Pat. No. 6,606,937 issued Aug. 19, 2003; U.S. Pat. No. 6,619,507 issued Sep. 26, 2004 and U.S. Pat. No. 6,702,253 issued Mar. 9, 2004; U.S. Pat. No. 6,708,598 issued Mar. 23, 2004, all issued to Zbigniew G. Lassota, and all of which are hereby incorporated by reference. What is significant is that these insulated dispensers have no active heating means, such as an electrical heater, infrared heater, microwave heater or the like to maintain the hot temperature of the beverage. This enables moving the beverage dispensers to a serving location without regard to whether electrical power is available at the serving location to power the active heater and, of course, eliminates the risks of power cords lying on the floor and otherwise causing entanglement.

What is unconventional about the insulated dispenser 10 of the present invention is that it has been retrofit with a pair of submersible passive heating units 12 that have been pre-heated to a temperature above the temperature of the beverage 14 as it is directly brewed into the interior 16 of the insulated dispenser 10. The exact temperature to which the passive heat units are pre-heated depends on how many of the heating units 12 will be used, the volume, or quantity, of beverage that is initially added to the interior 16, the initial temperature of the beverage 14, the efficiency of the insulation of the dispenser 10, and the temperature versus time characteristic that is desired.

The submersible passive heating units 12 are preferably heated to the desired temperature by a passive heating unit energizer 44, FIG. 8. They are then dropped or lowered into the interior of the 16 of the dispenser 10 before or after the beverage is added. Preferably, the passive heating units are smaller is cross dimension than the smallest diameter of the funnel passageway 24 so that the passive heating units 12 may simply be dropped through the funnel 22 into the interior 16. Regardless of how rapidly heated to the desired temperature, the passive heating units 12 preferably slowly, or gradually, release their heat energy to the beverage 14. This gradual release of heat assists in maintaining the relatively high temperature of the beverage 14 for a longer period of time than would be the case if only passive insulation was used to maintain the temperature. Because the release of heat energy is gradual, the heating units preferably do not actually elevate the temperature above the initial brewing temperature of the beverage. Instead, the passive heating only adds enough heat energy to compensate, at least until the temperature drops beneath the temperature of the beverage 14, for the loss of heat due to radiation and removal of beverage during serving.

In accordance with one aspect of the invention, the beverage is maintained by both passive heating and passive insulation, but it should be appreciated that passive heating of the present invention can be used to maintain temperature of the beverage regardless of the degree of insulation being provided by the dispenser body.

The unit energizer 44 may include any one of a plurality of heat sources including conduction heater, convection heater, radiant heater, electrical resistance heater electrical inductance heater and microwave heater and other like heaters that are capable of heating the inner core 48 to a desired high temperature. If the preheating is desired to occur during the time duration of a single complete brew cycle, such as 2-4 minutes, then the heater must have sufficient power and heating capacity to heat the passive heating unit 12 to the desired temperature during this brew cycle brew period. Otherwise, the a plurality of passive heating units may be pre-heated more slowly and kept on hand long before the beverage is brewed. Preferably, the passive heating unit 12 rapidly receives heat from the unit energizer 44, and then slowly releases the heat to the beverage 14. The total amount of heat energy required depends upon the nature of the material of the core 48 but the temperature should generally be raised to a temperature higher than the hottest initial temperature of the beverage, and thus will be raised to a temperature in excess of ninety-eight degrees-centigrade but probably not higher than two hundred sixty degrees-centigrade.

Referring to FIG. 2, the passive heating unit 12 preferably has an outer shell 46 made of material that is impervious to the hot freshly brewed coffee, tea or the like into which the heating unit is deposited. The outer shell 46 must be capable of withstanding the stresses of cyclic changes in temperature as the passive heating units 12 are heated to the desired operating temperature. This outer shell 46 is preferably made of stainless steal but any other material that is approved for use with food and which can withstand the rigors of normal use may be used for the outer shell material. Preferably, the outer shell has a relatively high heat conductivity characteristic. An advantage of stainless steel is provision of good thermal conduction to pass heat from an exterior source to the inner core 48 of heat retentive material to facilitate rapid heating of the inner core 48 during the heating cycle. The stainless steel, of course, also provides good thermal conduction from the core 48 to the beverage 14 during the passive heating cycle when the core 48 is cooling within the interior 16 of the dispenser assembly 10.

The outer shell protectively surrounds and contains an inner core 48 of suitable material that can adsorb and retain heat to be gradually released through the outer core 46 and into the beverage 14 into which the passive heating units 12 are immersed. Different heat retention materials for the cored 46 may be used. One such material is ceramic material. The interior of the core 48 may be provided with an embedded electrical heater element 47 that may be heated through a suitable electrical connection 49 that extends through the core 48 and the outer shell 46 for connection to an electrical source. Also, the interior of the core 48 may be provided with an embedded rechargeable electrical energy storage device, such as a capacitor or a rechargeable battery, that may be used to power the electrical heater element 47 and is also connectable through connector 59 to a source of electrical charging power. If the material of the core 48 is not capable, itself, of being heated with microwave or other radiant heating, then the interior of the core 48 may be provided with a pocket 50 of material that may be heated by microwave or other radiant energy. This pocket 50 of material then, in turn, heats the heat retentive material of the core 45 from within the interior. Alternatively, the core 48 material itself may be capable of being heated by microwave or other radiant heating means.

Regardless of the heating technique used, in the case of interior heating, it is not needed to have a highly heat conductive outer shell 46, and instead of stainless steel, the outer shell 46 may be made of material with a relatively low thermal conductivity characteristic, such as ceramic material, to slow the release of heat from the cored 48.

Instead of using ceramic material for the core 48, phase change materials that adsorb heat energy by changing between one phase to another and then give up the thermal energy as they change back from the other phase to the one phase may be used.

Generally, the phase transition is from the solid phase to the liquid phase during the heat storage cycle either before or during the brew cycle of the beverage brewer 42. Then as the temperature of the phase change material is reduced by giving up heat energy to the beverage 14 during serving, the phase change material reverts from the liquid phase back to the solid phase and in the process releases the heat absorbed during the reverse transition. Such phase change materials, or PCM's, include hydrated salts, eutectic salts and paraffin. Thermal energy is stored during heating of the thermally dehydrated salt. Such PCM materials contained in a suitable capsules for use in the passive heating units can be obtained from PCM THERMAL SOLOUTIONS of Naperville, Ill. and Sunnyvale, Calif. and are also commercially available from GSA RESOURCES, INC. at www.gsaresorces.com. PCM brand names include T.E.A.P. TH29, TH58 and TH89 or some combination needed to achieve the desired temperature range.

The phase change materials may be in a variety of forms, such as linear alkyl crystalline alkyl hydrocarbons, alkyl hydrocarbon waxes, crystalline fatty acids, linear crystalline primary alcohols, ethylene copolymers, polyethylene, polyethylene glycol, polyethylene oxide and acetamide, such as described in U.S. Pat. No. 6,108,589 issued Aug. 22, 2000 to Frohlich et al., which is hereby incorporated by reference.

Another source of heat storage material for use in the core 48 of the passive heating units includes discrete particles of a solid organic particulate material that is solid at room temperature and exhibits a mesocrystalline transition temperature within a range of about thirty degrees-centigrade to about two hundred degrees-centigrade, such as described in U.S. Pat. No. 4,983,798 issued Jan. 8, 1991 to Eckler et al, which is hereby incorporated by reference.

In the embodiment of FIG. 1, the passive heating units are deposited into the interior 16 of the beverage dispenser assembly 10 simply by dropping them through the funnel opening 23 at the bottom of the funnel assembly 22. Alternatively, the funnel assembly 22 is temporarily removed from its funnel mounting hole 27 in the insulated top cover 20 and the passive heating units 12 are dropped through the mounting hole 27. If it is desired to provide relatively larger passive heating units with greater heat adsorption capabilities that are larger than the mounting hole 27, then the entire cover 20 may be removed to allow the relatively larger passive heating units 12 to be dropped into the interior 16 of the dispenser assembly 10. In the case of the funnel assembly 22 having to be removed or the cover 20 having to be temporarily removed to enable locating the relatively larger passive heating units 12 into the interior, the relatively larger passive heating units 12 are preferably added to the interior 16 prior to the commencement of a brew cycle. This is to prevent the loss of heat from the beverage 14 through the mounting hole 27 or the open top 18 after the beverage has been brewed directly into the interior 16. On the other hand, if the passive heating units 12 are small enough to be passed through narrowest part of the funnel passageway 24, then the passive heating units may be dropped into the interior at the conclusion of the brew cycle and before the funnel cover 26 is moved to a closed position. The passive heating elements 12 that are designed to be simply dropped into or otherwise placed into the interior 16 without any other connection to the dispenser assembly 10 are made to be denser than the beverage and accordingly sink to and remain on the bottom 17 of the interior 16.

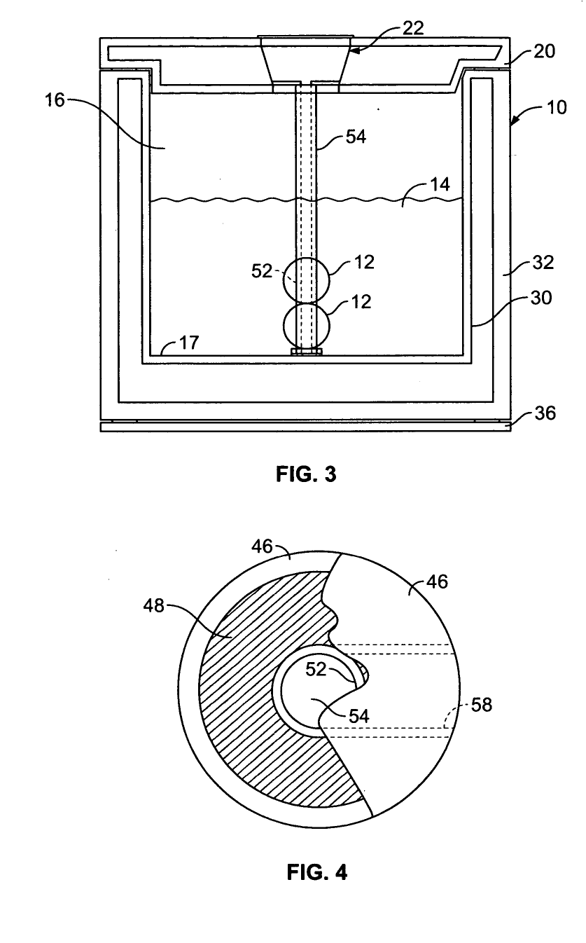

Referring to FIGS. 3 and 4, the passive heating unit 12 may be provided with a central mounting opening 52 through which is passed the cylindrical body of a down tube 54 of the funnel assembly 22. The down tube 54 is well known and is used to pass the hot beverage received into the funnel assembly 22 to an interior location adjacent the bottom 17 of the interior of the beverage dispenser assembly 10. In accordance with one aspect of the invention, the passive heating units 12 are provided with a central mounting hole 52 within which the down tube 54 is slideably received to releasably mount the passive heating units 12 to the down tube 54. A releasable collar 56 at the bottom of the down tube 54 blocks the passive heating units 12 from falling off the bottom end of the down tube 54. Alternatively, a generally C-shaped slot, shown in broken line 58, is formed in the passive heating unit 12 to enable lateral mounting of passive heating units onto the body of the down tube 54. Alternatively, the passive heating units 12 are slid onto the top end of the down tube 54 and the collar 56 may be fixedly mounted to the bottom end of the down tube 54. Advantageously, when the passive heating units 12 are mounted to the down tube 54, the removable down tube 54 may be used as a handle to lower the passive heating units 54 into the interior 15 before the brew cycle or to raise them off the bottom 17 after the dispenser assembly has been depleted of beverage to enable cleaning of the interior 16, the down tube 54 and the funnel assembly 22 and to recharge or re-energize the passive heating units 12 to prepare them for re-use.

Referring to FIG. 7, alternatively, a special removable, elongate handle 60 may be used that is releasably connected at a bottom end to a releasable female connector 62 carried by the shell 46 of the passive heating unit 12. The top end of the handle 60 may be provided with a fixedly mounted or removably mounted conical collar 64 with a handle 66. The conical collar may be received in a special mounting opening in the top closure 20 or may be fitted into the bottom of the funnel assembly 22 in the absence of a down tube 54. In the case of the passive heating unit 12 being mounted to the handle assembly 60 or to the down tube 54 in such a fashion that the passive heating unit is prevented from floating upwardly off the bottom 17, the passive heating unit 12 may be less dense than the beverage. It is preferred to have the passive heating units 12 at the bottom 17 of the interior space 16 to keep the passive heating units 12 submerged as much as possible for maximum surface contact of the outer shell 46 with the beverage and to prevent loss of heat into the empty portion of the interior space 16 located above the surface of the beverage 14.

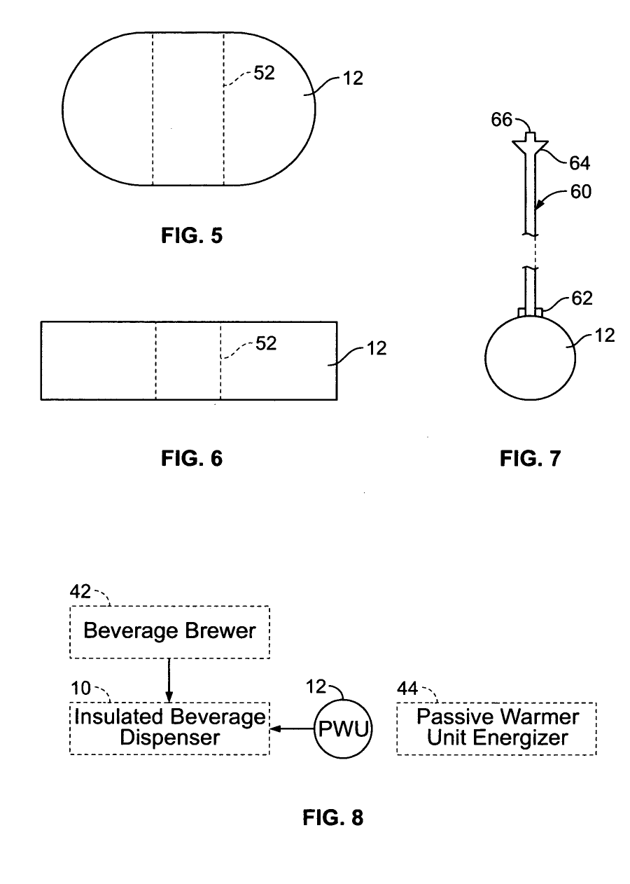

Referring to FIGS. 5 and 6, the passive heating unit 12 is not necessarily in the shape of a sphere. In the embodiment of FIG. 5, the passive heating unit 12 is in the shape of an ovoid with a cylindrical body extending between hemispherical ends. In the embodiment of FIG. 6 the passive heating unit 12 has a cylindrical configuration. In passive heating units of FIGS. 5 and 6 may be provided with a mounting hole 52, as shown in FIGS. 5 and 6, or with releasable handle connectors, as shown in FIG. 7 or a C-shaped slot 58, as shown in FIG. 4.

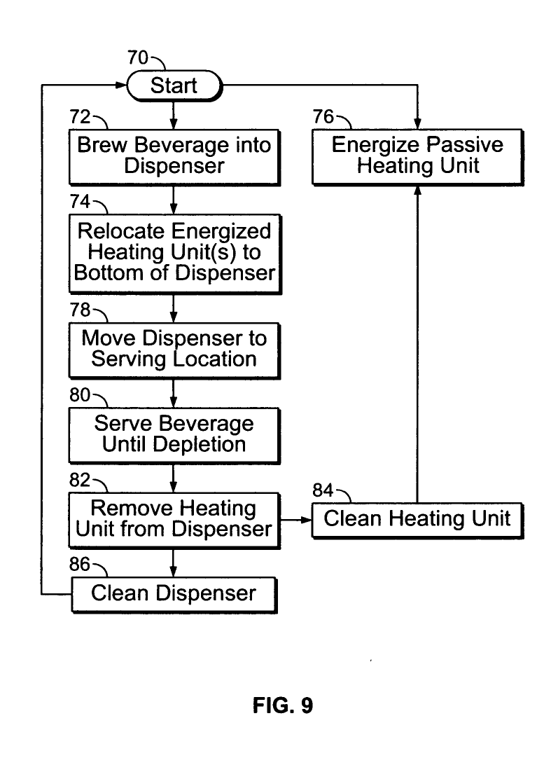

Referring to FIG. 9, in accordance with the present invention, the first step of the method of serving freshly brewed beverage from a dispenser after the start 70 is the step 72 of brewing beverage directly into the insulated beverage dispenser assembly 10. Then if this step has not already been performed before the performance of step 72, as may be preferred depending upon circumstances, as indicated above, in step 74 the energized, or pre-heated passive heating units 12 are relocated to the bottom 17 of the dispenser assembly 10. In step 76, the passive heating units 12 are energized by means of application of a suitable source of heating power, as indicated above. As noted above, this step 76 is performed either entirely during the performance of step 72 or is performed prior to step 72. In any event, step 76 is performed prior to step 74, regardless of whether step 74 is performed before or after step 72.

After the completion of the brew cycle in step 72 and reception through the brew-through funnel assembly 22 of a batch of freshly brewed beverage 14, and completion of step 74, and all covers 20 and 26 are closed, the dispenser assembly is moved to a serving location, in step 78. The dispenser assembly 10 is moved on a serving cart or is carried by hand to a serving location. This serving location needs no source of electrical power because the beverage is kept above a minimum serving temperature for a sufficiently long time to complete service of all beverage 12 within the dispenser assembly 10, in step 80. In step 82, the dispenser is removed from the serving location and moved to a cleaning location where the passive heating unit or units 12 are removed from the interior 16. Removal is effected by removing the cover 20 and reaching inside to manually remove the unconnected passive heating unit 12 or by use of the down tube 54 or the handle 60, as indicated above. The heating unit is cleaned in step 84 and then returned to the passive heating unit energizer for repetition of step 76. In step 86, the dispenser assembly 86 is cleaned and then returned to service for receipt of another batch of freshly brewed beverage.

Alternatively, the above steps are followed except that step 74 is performed after relocation of the beverage dispenser assembly 10 to the service location. In such case, there may be a supply of energized, pre-heated passive heating units located at the service location. The pre-heated passive heating units 12 may be energized at the brewing location or a service station adjacent the serving location. Alternatively, the step 76 of energizing the passive heating units 12 may be performed with a passive heating unit energizer located at a service station located near the service location or at the service location, itself. In such case, availability of electrical power at the service station or service location is required.

The step 74 of relocating energized passive heating units to the bottom of the dispenser assembly 10 includes the step of first deciding how many passive heating units 12 to place into the interior 16 depending upon the size of the batch of beverage 14 has been or will be brewed directly into the dispenser 10. Additionally, or alternatively, step 12 includes the step of selecting the number of heating units to be inserted into the interior space 16 depending upon the length of time that it is desired to keep the beverage above minimum serving temperature.

In the case of provision of a supply of passive heating units of different size and warming capacity, the step 74 includes the step of deciding which size of passive heating unit to employ as well as how many of each size to employ depending upon batch size and minimum temperature maintenance time duration desired.

If the passive heating unit energizer is capable of pre-heating, or energizing, the passive heating units 12 to different levels, then the step 74 includes the step of deciding the level of heating for each of the passive heating units to be used. While larger passive heating units 12 will normally be pre-heated to a greater extent than relatively smaller passive heating units 12, passive heating units 12 of the same size may be selected for pre-heating to different levels. The decision with respect to the level of heating of each passive heating unit to be used depends again on the size and number of passive heating units 12 to be use as well as on the batch size and desired minimum service temperature maintenance time duration.

The actual levels of heating, size and number of passive heating units required for any given minimum temperature maintenance duration is dependent upon the insulating qualities of the insulated dispenser assembly 10 as well as the initial temperature of the beverage that is brewed into the dispenser, and, thus, can only be determined by experiment with each different type or model dispenser.

While particular embodiments of the invention have been disclosed in detail, it should be appreciated that many variations to these details may occur to those skilled in the art that do not depart from the scope and spirit of the invention as set forth in the appended claims.

For instance, although a number of different phase change materials have been mentioned or referred to, it should be appreciated that any phase change material like those mentioned may be used. Likewise, although the use of ceramic material may be used in accordance with different aspects of the invention, it should be appreciated that other materials that have similar durability and thermal characteristics may be used in lieu of the use of ceramic material in the manner indicated. In addition, while particular shapes have been indicated for the passive heating elements 12, it should be obvious that other shapes, such as rectilinear, outwardly radiating arms or even discs that cover substantially the entire bottom of the dispenser may be employed.

With reference to the dispenser assembly 10, while a dispenser assembly of the type having a faucet connected to the bottom of the interior space 16 has been illustrated, it should be appreciated that the broadest aspects of the invention are applicable to any container that contains a hot beverage that is to be kept warm. Such other containers, of course, include insulated air pot dispensers in which the beverage is pumped out of the interior of the dispenser through a nozzle located adjacent the top of the air pot dispenser.

The passive heating elements 12 could also be downsized for use in open glass carafes, insulated or noninsulated pouring urns and even individual serving cups. In the case of use with serving cups, either insulated or not, either with closure tops or not, the passive heating unit 12 should be made of relatively inexpensive materials to make it disposable and may be made as part of a disposable serving cups. In such case, the phase change material would be contained within a plastic pouch or cavity built into the serving cup. Alternatively, a discount on the next cup of coffee may be given for return of each special self-heating cup or serving cup-sized passive heating element that may be cleaned and reused.

Further, while the decisions as to how many and the size of the passive heating units and the extent of energizing of the passive heating units 12 for a given temperature maintenance objective for any given circumstance, once determined empirically, electronically stored and then provided automatically on an electronic display under control of a properly programmed microcomputer, ASIC, display lights or the like to the user, as messages or graphic images, that provide the needed information. This display may be associated with either the brewer or the dispenser. In either case, the display may be shared to display other information unrelated to the use of the passive heating elements to obtain a dual benefit. Alternatively, the brewer controller is connected to the controller of the passive heating unit energizer and automatically controls the energizer depending upon the parameters of initial beverage temperature, batch size, minimum serving temperature, brew cycle duration and passive heating unit size.

Alternatively, in a retrofit application, the controller for controlling the passive, heating element energizer preferably has a display and a microprocessor that has been programmed for controlling the display to show the needed information. One or more different types, makes or models of one or more manufacturers of composite beverage brewing systems that have a fresh beverage brewer and an associated beverage dispenser with a brew through lid, or cover, may be used with the present invention. Accordingly, the passive heating unit is preferably provided with a controller with a memory of the extent of energization needed for each different make and model of composite brewer for different sized passive heating units, different desired minimum temperature maintenance time duration, different minimum temperatures and different initial beverage temperatures and different brew cycle durations. The operator may then input the make and model of the brewer system and input these different parameters into the energization controller, and based on this information, the controller will automatically select the rate and level of energization required to achieve the desired results for the make and model.

Alternatively, the controller will simply display the results and allow the operator select the rate of heating and the minimum heating time required to bring the passive heating unit to the desired level of heat retention to achieve the desired results.

1. An beverage dispenser, comprising:
a beverage dispenser assembly with a hollow body with an interior for receipt of hot beverage at an initial beverage temperature;
a beverage submersible passive heating element having body with an interior and an outer surface made of material substantially impervious to contact with hot beverage and having an initial internal temperature significantly greater than the initial beverage temperature to transfer heat from the interior of the body to any beverage within the container, said self-contained passive heating element being contained within the interior of the hollow body.

2. The beverage dispenser of claim 1 in combination with a passive heating unit energizer for selectively heating the passive heating unit to the desired initial internal temperature.

3. The beverage dispenser of claim 1 in which the volume capacity of the interior of the hollow body is sufficient to hold a plurality of individual servings of beverage of approximately four to sixteen ounces.

4. The beverage dispenser of claim 1 in which the hollow body has an insulated side, bottom and top, and a manually operated dispensing apparatus for dispensing beverage from the bottom and in which the passive heating unit is located adjacent the bottom and provides the only source of heat for maintaining the temperature of the beverage within the interior.

5. The beverage dispenser of claim 1 in which the passive heating unit is submerged in the beverage when contained within the interior of the hollow body.

6. The beverage dispenser of claim 1 in which interior of the hollow body has a bottom and the passive heating unit is supported by the bottom.

7. The beverage dispenser of claim 1 in which the passive heating unit is self-contained and disconnected from any exterior electrical power source.

8. The beverage dispensers of claim 1 in which the passive heating unit has a handle that extends upwardly from the bottom and toward the top for manual removal of the passive heating unit.

9. The passive heating unit of claim 1 in which the interior of the hollow body has a bottom and dispenser assembly has a vertical tube that extends vertically in the interior of the hollow body from adjacent the bottom for passing beverage and the passive heating unit has means for releasably mounting the passive heating unit to the vertical tube adjacent the bottom.

10. The beverage dispenser of claim 1 in which the dispenser has a top cover with a mounting hole for releasable attachment of a of brew-through funnel assembly, said mounting hole having a diameter and the passive heating unit has a body with a minimum cross dimension to enable the passive heating unit to be dropped through the mounting hole.

11. The beverage dispenser of claim 1 in which the hollow body has an open top with an opening having a diameter and a closure cover releasably mounted to the open top and the passive heating unit has a minimum cross dimension to enable the passive heating unit to be dropped through the mounting hole.

12. The beverage dispenser of claim 1 in which the passive heating unit has an outer shell made of beverage impervious material and an inner core made of heat retentive material.

13. The beverage dispenser of claim 1 in which the passive heating unit is at least partly made of ceramic material.

14. The beverage dispenser of claim 1 in which the passive heating unit with an outer shell made of metal and an interior core made of a phase change material that when heated above a characteristic phase change temperature changes phase and adsorbs thermal energy when changing phase that is released through the outer shell and into the beverage as the core cools within the interior of the hollow body.

15. The beverage dispenser of claim 1 in combination with a passive heating unit energizer that heats the passive heating unit internally through radiation.

16. The beverage dispenser of claim 1 in which the passive heating unit has an interior made of heat retentive material and including an electrical heating element mounted in a pocket within the interior of the passive heating unit and connectable with an external source of electrical power to heat the heat retentive material.

17. The beverage dispenser of claim 1 in which the passive heating unit has an interior made of heat retentive material and including an electrical energy storage device mounted within a pocket within the interior of the passive heating unit and connectable with an external source of electrical power to charge the electrical energy storage device.

18. The beverage dispenser of claim 1 in which at least one of (a) a beverage brewer that forms a part of a brewing system in combination with the beverage dispenser and is fitted relative to the dispenser to enable direct receipt of freshly brewed beverage through a brew-through funnel assembly, (b) the beverage dispenser assembly, and (c) a passive heating element energizing unit especially adapted for heating the passive heating unit has a controller with a memory of heating requirements for heating the passive heating units to the extent needed to achieve selected minimum beverage service temperature maintenance results depending upon different parameters including batch size.

19. The passive heating unit of claim 1 in combination with a passive heating unit energizer for heating at least one passive heating unit by at least one of (a) heat convection, (b) external heat radiation and (c) microwave radiation.

20. A submersible passive heating unit for passively heating a beverage in which the passive heating unit is submersed, comprising:
a core made of heat retentive material; and
an exterior surface made of material that is impervious to hot beverages and approved for contact with food during commercial preparation.

21. The passive heating unit of claim 20 in which the core is made of a phase change material.

22. The passive heating unit of claim 20 in which the exterior surface is made of metal that is highly noncorrosive in the presence of hot acidic beverages, relatively stainless and approved for use with food commercially prepared.

23. The passive heating unit of claim 20 in which both the core and the exterior surface are made of the same heat retentive material.

24. The passive heating unit of claim 20 in which the core is made of ceramic material.

25. The passive heating unit of claim 20 in which the exterior surface is made of stainless steel and the core is made of one of (a) ceramic material or other like material with respect to heat retention characteristics and (b) phase change material.

26. The passive heating unit of claim 20 in which the core has a pocket with one of (a) a rechargeable energy storage device connectable to an exterior electrical power recharging source, such as a rechargeable battery or a relatively low-leakage capacitor.

27. The passive heating unit of claim 20 in combination with a passive heating unit energizer

28. The passive heating unit of claim 20 in which the core is preheated to a temperature significantly greater than the initial beverage temperature into which to transfer heat from the interior of the body to any beverage within the container, said self-contained passive heating element being contained within the interior of the hollow body.

29. The beverage dispenser of claim 20 in combination with a passive heating unit energizer for selectively heating the passive heating unit to a desired initial internal temperature needed for maintaining the temperature of a beverage into which the passive heating unit is submerged.

30. The beverage dispenser of claim 20 in combination with a beverage dispenser with a volume capacity sufficient to hold a plurality of individual servings of beverage of approximately four to sixteen ounces.

31. The passive heating unit of claim 20 in combination with a beverage dispenser containing beverage in which the passive heating unit is submerged.

32. The passive heating unit of claim 20 in combination with a beverage dispenser having a hollow body with a bottom, said passive heating unit being supported by the bottom.

33. The passive heating unit of claim 20 in which the passive heating unit is self-contained and disconnected from any exterior electrical power source.

34. The passive heating unit of claim 20 in which the passive heating unit has a handle.

35. The passive heating unit of claim 20 in combination with a dispenser having a hollow body with an interior with a bottom and dispenser assembly having a vertical tube that extends vertically in the interior of the hollow body from adjacent the bottom for passing beverage and the passive heating unit has means for releasably mounting the passive heating unit to the vertical tube adjacent the bottom.

36. The passive heating unit of claim 20 in combination with a beverage dispenser witnh a hollow body having an interior with a top cover with a mounting hole for releasable attachment of a of brew-through funnel assembly, said mounting hole having a diameter, and the passive heating unit having a body with a minimum cross-dimension to enable the passive heating unit to be dropped through the mounting hole into the interior of the interior.

37. The passive heating unit of claim 20 in which the exterior surface is the exterior surface of an outer protective shell made of beverage impervious material made from material that is different from the core of heat retentive material.

38. The passive heating unit of claim 20 in which the passive heating unit is at least partly made of ceramic material.

39. The passive heating unit of claim 20 in which the exterior surface is the exterior surface of a protective outer shell made of metal and the interior core is made of phase change material that when heated above a characteristic phase change temperature changes phase and adsorbs thermal energy when changing phase that is released through the outer shell and into any beverage in which it may be immersed as the core cools.

40. The passive heating unit of claim 20 in combination with a passive heating unit energizer that is specially adapted to heat the passive heating unit internally through radiation.

41. The passive heating unit of claim 20 including an electrical heating element mounted in a pocket within the core and connectable with an external source of electrical power to heat the heat retentive material.

42. The passive heating element of claim 20 including an electrical energy rechargeable storage device mounted within a pocket within the core and connectable with an external source of electrical power to charge the electrical energy storage device.

43. The passive heating element of claim 20 beverage dispenser of claim 1 in combination with at least one of (a) a beverage brewer that forms a part of a brewing system in combination with the beverage dispenser and is fitted relative to the dispenser to enable direct receipt of freshly brewed beverage through a brew-through funnel assembly, (b) a beverage dispenser assembly, and (c) a passive heating element energizing unit especially adapted for heating the passive heating unit, having a controller with a memory of heating requirements for heating the passive heating units to the extent needed to achieve selected minimum beverage service temperature maintenance results depending upon different parameters including batch size.

44. The passive heating unit of claim 20 in combination with a passive heating unit energizer for heating at least one passive heating unit by at least one of (a) heat convection, (b) external heat radiation and (c) microwave radiation.

45. A method of maintaining freshly brewed beverage, comprising the steps of:
depositing freshly brewed beverage into a beverage container;
submerging in the freshly brewed beverage at least one energized passive heating unit having heat retentive material and a temperature greater than that of the beverage;
passing heat from the passive heating unit to the beverage to assist in maintaining the temperature of the beverage above a preselected minimum service temperature; and

46. The method of claim 45 including the step of energizing the passive heating unit prior to the step of submerging by heating the passive heating unit by at least one of (a) convection heating, (b) radiant heating and (c) microwave heating.

47. The method of claim 45 including the step of insulating the container to assist the passive heating element in maintaining the beverage temperature above the preselected minimum serving temperature.

48. The method of claim 45 including in which the passive heating unit is made in part of phase change material and including the step of heating the passive heating unit until the phase change material adsorbs sufficient heat energy to change phase prior to the step of submerging.

49. The method of claim 45 in which the passive heating unit is made in part of phase change material and including the step of releasing heat energy into the beverage from the passive heating unit as the phase change material is lowered in temperature and changes phase.

50. The method of claim 45 in which the container is an insulated dispenser with a top with an closable opening and in which the step of submerging is performed by dropping the passive heating unit through the closable opening.

51. The method of claim 45 including the steps of manually removing the passive heating unit from the container, cleaning the passive heating unit, reenergizing the passive heating unit to prepare it for reuse.

52. The method of claim 45 in which the passive heating unit includes a metal shell protectively surrounding a core of heat retentive material, and including the step of passing heat through the metal shell to heat the heat retentive material prior to the step of submerging and passing heat from the core through the metal shell into the beverage after the step of submerging.

53. The method of claim 45 including the step of storing different heating directions for heating the passive heating unit for a plurality of different parameters.
